(19) United States
(12) Patent Application Publication
(10) Pub. No.: US 2005/0204958 A1
(43) Pub. Date: Sep. 22, 2005

(54) Platelike effect pigments with a melamine formaldehyde resin coating

(76) Inventors: Armin Kuebelbeck, Bensheim (DE); Ralf Anselmann, Ramsen (DE); Jens Eichhorn, Reinheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/506,326

(22) PCT Filed: Feb. 27, 2003
(86) PCT No.: PCT/EP03/02020

§ 371 Date: Sep. 2, 2004

(30) Foreign Application Priority Data
Mar. 2, 2002 (DE) 10209359.8
Oct. 8, 2002 (DE) 02022552.0

(51) Int. Cl. C09K 11/06; B32B 5/16

(52) U.S. Cl. 106/403; 106/415; 106/499; 106/491; 252/301.16; 428/407

(57) ABSTRACT

Coated platelet-shaped carrier material composed of an inorganic substrate provided with at least one coating, each layer comprising at least one cured melamine-formaldehyde resin or being composed of such a resin, and also a process for preparing the coated carrier material and its use as effect pigment.

The invention relates to platelet-shaped substrates coated with cured melamine-formaldehyde resins, to a process for preparing them, and to their use as effect pigments.

The use of platelet-shaped carrier materials, such as mica platelets, silica flakes, glass platelets or aluminium flakes, for preparing effect pigments, such as flake pigments, is widely known. In this utility the carrier materials serve as templates for the deposition of generally inorganic oxide layers, such as titanium dioxide, zirconium dioxide or iron oxides, which in certain cases may optically interact with the substrate by interference. Pigments of this kind are known, for example, from DE 1467468, DE 1959998 and DE 2009566. Silica flakes and also their preparation are described in WO 92/02351 and WO 93/08237. EP 0810270 discloses aluminium-based pigments provided with an acidic adsorption layer with a colour pigment layer thereon.

The coating or encapsulation of surfaces with melamine resins is likewise known from the literature; for example, DE 19710619 describes the coating of solid, hard particles with melamine resin for decorative, abrasion-resistant coatings.

EP 601378 discloses a water-based coating material in which the coating of mica flakes with uncured melamine resin proves to be favourable for the processing properties of the coating material and for the stability of dispersion.

Improved wettability of toner particles coated with various resins, including melamine resin, is described in JP 130787.

DD 224 602 and EP 445 342 disclose acid-crosslinked and precipitated melamine resin particles into which water-soluble dyes containing amino or sulphonic acid groups can be incorporated.

One of the objects of the present invention was to provide effect pigments which are colourable, have a high brightness and, in the case of cosmetic applications, possess a high level of skin comfort.

This object has been achieved by the provision of a coated platelet-shaped carrier material, the carrier material being composed of an inorganic substrate and being provided with at least one coating, each coat comprising at least one crosslinked melamine-formaldehyde resin or consisting of one such resin.

Suitable substrates include in principle all inorganic platelet-shaped carrier materials. By a platelet-shaped substrate is meant a substrate having a substantially flat, in particular leafletlike or flakelike, shape. Suitable examples include micas, such as muscovite, phlogopite, fluorophlogopite or other silicatic platelets, silica flakes or glass flakes, but also metal flakes or metal foils, such as those of silver, copper, nickel, gold, aluminium or alloys of these metals. Also possessing particular suitability as platelet-shaped inorganic substrates are pearlescent pigments which are composed, for example, of mica, silica flakes or glass and one or more metal oxide layers deposited thereon. The metal oxide layer may be composed, for example, of titanium dioxide, titanium oxide mixed with iron(III) oxide, iron (III) oxide, chromium oxide, zirconium dioxide, tin dioxide or zinc oxide. Pigments of this kind are available commercially under the name Iriodin® (manufacturer: E. Merck, Darmstadt).

Not only the non-metallic but also the metallic carrier materials may possess a metallic coating comprising the aforementioned metals or alloys thereof.

In the crosslinked melamine-formaldehyde resins, some of the melamine molecules may also have been replaced by other crosslinkable molecules, such as phenols, guanamines or urea. The melamine-formaldehyde resins may be unetherified or etherified melamine-formaldehyde adducts, for example alkoxymethylol-melamines having C₁-C₆ alkoxy groups, such as methoxy or n-butoxy groups, and precondensates. As examples, mention may be made of Madurit MW 909 as an unetherified resin or Madurit SMW 818 as an etherified resin (both products of Solutia, Wiesbaden, Germany). Some of the melamine-formaldehyde resin may also be replaced by other crosslinking organic polymers. Particularly suitable in this respect are those which likewise possess a high refractive index, especially those possessing a refractive index which is greater than that of the substrate.

Any desired organic and inorganic dyes and also, where appropriate, colourless UV absorbers may be incorporated into the melamine-formaldehyde resins. The critical factor for incorporation into the polymer matrix in this case is simply their solubility in the medium in which the coating reaction is conducted. Even water-soluble dyes, such as eosin, fluorescein or Victoria Pure Blue BO, can be embedded into the polymer matrix without subsequent bleeding. In the case of lipophilic dyes, the coating reaction may likewise be conducted in an aqueous medium if the solubilizers familiar to the person skilled in the art are added. An example that may be mentioned of a solubilizer here is 1-methyl-2-pyrrolidone.

In order to obtain colour shades, it is possible to make use of the standard principles of additive colour mixtures. In this case the shades can be obtained by mixing the dyes beforehand and introducing them together into a polymer layer or by applying two or more dye-polymer layers to the inorganic substrate in succession, so that layers of different colour are superimposed on one another.

Acidochromic dyes as well, i.e. dyes whose colour depends on pH, may be incorporated into the melamine-formaldehyde resin while substantially retaining their shade and colour-change point. By way of example, mention may be made here of phenolphthalein, bromothymol blue, bromoxylene blue and thymolphthalein.

As well as fluorescein, already mentioned above, other fluorescent dyes, optical brighteners or other UV-absorbing dyes may be incorporated into the polymer matrix.

It is particularly advisable to incorporate two or more dyes of which at least one is a fluorescent dye. Particularly advantageous is the incorporation of at least two fluorescent dyes, the second fluorescent dye being added in considerably reduced quantities. This allows pigments to be obtained whose resulting fluorescent colour differs markedly from the fluorescent colour of the starting materials. It is possible in this way to synthesize a multiplicity of differently fluorescing pigments in a simple way. By varying the nature of the fluorescent dye or dyes and varying both the nature and the concentration of the second dye, added in considerably reduced quantities, it is possible to generate a wide range of fluorescent colours. In many cases, owing to the small fraction of colour-determining dyes, these pigments are very inconspicuous and comparatively pale in visible light. Besides the basic colours of red, green and blue, well over a hundred different fluorescent colours readily distinguishable with the naked eye can be realized. The diversity of fluorescent pigments obtainable in this way can be used, for example, for coding products such as seed. The coding possibilities, however, go well beyond the differentiation possibilities that are detectable to the eye. In particular, the use of fluorescence detectors opens up the possibility of a strongly shaded coding or marking of products. For example, by varying the concentration of a certain colour pigment on the one hand and the number of colour pigments used in total on the other hand, a multiplicity of colour shades can be achieved which is ultimately limited only by practical considerations. For example, when using five colour pigments each present in eight discrete concentration stages, it is already possible to obtain more than 4 000 coding possibilities. With ten fluorescent colours and fourteen concentrations, indeed, the coding possibilities run to more than 20 billion. Naturally, this presupposes the use of a very large statistical amount of pigment particles, something which can be achieved, for example, by a large surface area available for measurement and evaluation or by very small pigment particles and highly sensitive detectors. Markings using two or more colour pigments in different concentration stages can be utilized for a variety of applications. For example, a manufacturer of commodity articles may provide its products with a variety of information such as, for example, the year of manufacture and the batch number by printing with a coating material comprising the fluorescent pigments described. Such information may also be used, among other things, for product protection, by allowing one's own products to be identified rapidly and so distinguished from products from unauthorized manufacturers or distributors (product piracy).

By depositing a polymer layer comprising one or more fluorescent dyes on a dye-containing polymer layer applied beforehand, it is possible to achieve a marked increase in the brightness and luminosity of the effect pigments. Furthermore, it is possible to inhibit fading of the underlying layers through the absorption of UV light. UV protection of this kind may also be achieved through the incorporation of UV absorbers into the dye-containing polymer layer itself.

Suitable UV absorbers include in principle all UV filters. Particularly preferred UV filters are those whose physiological acceptability has been demonstrated. Both for UV-A and for UV-B filters, there are many established substances known from the technical literature. Mention may be made here, for example, of benzylidenecamphor derivatives, such as 3-(4′-methylbenzylidene)-d1-camphor, 3-benzylidene-camphor, polymers of N-{(2 and 4)-[(2-oxoborn-3-ylidene)methyl]benzyl}acrylamide, N,N,N-trimethyl-4-(2-oxoborn-3-ylidenemethyl)anilinium methyl sulphate or α-(2-oxoborn-3-ylidene)toluene-4-sulphonic acid, benzoylmethanes or dibenzoylmethanes such as 1-(4-tert-butylphenyl)-3-(4-methoxyphenyl)propane-1,3-dione or 4-isopropyldibenzoylmethane, benzophenones such as 2-hydroxy-4-methoxybenzophenone or 2-hydroxy-4-methoxybenzophenone-5-sulphonic acid and its sodium salt, methoxycinnamates such as octyl methoxycinnamate, isopentyl 4-methoxycinnamate and its isomer mixture, salicylate derivates such as 2-ethylhexyl salicylate, 4-isopropylbenzyl salicylate or 3,3,5-trimethylcyclohexyl salicylate, 4-aminobenzoic acid and its derivatives such as 2-ethylhexyl 4-(dimethylamino)benzoate or ethoxylated ethyl 4-aminobenzoate, and further substances such as 2-ethylhexyl 2-cyano-3,3-diphenylacrylate, 2-phenylbenzimidazole-5-sulphonic acid and its potassium, sodium and triethanolamine salts, 3,3′-(1,4-phenylenedimethylene)bis(7,7-dimethyl-2-oxobicyclo[2.2.1]hept-1-ylmethanesulphonic acid and its salts, and 2,4,6-trianilino-(p-carbo-2′-ethylhexyl-1′-oxy)-1,3,5-triazine.

Further suitable organic UV filters are, for example, 2-(2H-benzotriazol-2-yl)-4-methyl-6-(2-methyl-3-(1,3,3,3-tetramethyl-1-(trimethylsilyloxy)disiloxanyl)-propyl)phenol, 4,4′-[(6[4-((1,1-dimethylethyl)aminocarbonyl)phenylamino]-1,3,5-triazine-2,4-diyl)diimino]-bis(2-ethylhexyl benzoate), α-(trimethylsilyl)-ω-[(trimethylsilyl)oxy]poly[oxy(dimethyl [and about 6% methyl[2-[p-[2,2-bis(ethoxycarbonyl]vinyl]phenoxyl]-1-methylene ethyl] and about 1.5% methyl[3-[p-[2,2-bis(ethoxycarbonyl)vinyl)phenoxy)propenyl) and 0.1 to 0.4% (methylhydro]silylene]] (n≈60) (CAS No. 207 574-74-1), 2,2′-methylenebis-(6-(2H-benzotriazol-2-yl)-4-(1,1,3,3-tetramethylbutyl)phenol), 2,2′-(1,4-phenylene)bis(1H-benzimidazole-4,6-disulphonic acid, monosodium salt) and 2,4-bis{[4-(2-ethylhexyloxy)-2-hydroxy]phenyl}-6-(4-methoxyphenyl)-1,3,5-triazine.

Preferred compounds having UV-absorbing properties are 3-(4′-methylbenzylidene)-dl-camphor, 1-(4-tert-butylphenyl)-3-(4-methoxyphenyl)propane-1,3-dione, 4-isopropyldibenzoylmethane, 2-hydroxy-4-methoxybenzophenone, octyl methoxycinnamates, 3,3,5-trimethylcyclohexyl salicylate, 2-ethylhexyl 4-(dimethylamino)benzoate, 2-ethylhexyl 2-cyano-3,3-diphenylacrylate, and 2-phenylbenzimidazole-5-sulphonic acid and its potassium, sodium and triethanolamine salts.

By combining two or more UV filters it is possible to optimize the protective effect against damaging exposure to UV radiation.

The coated platelet-shaped substrates may be prepared by depositing crosslinking melamine-formaldehyde resins on the suspended platelet-shaped substrates and then curing, i.e. crosslinking, the melamine-formaldehyde resins.

The process of the invention for preparing a singly or multiply coated platelet-shaped carrier material comprises, in the case of a single coating, a first step in which an inorganic platelet-shaped substrate is suspended in a basic aqueous medium, comprising melamine and formaldehyde and/or methylolunelamine, which may optionally have been alkoxylated, and
a second step in which crosslinking of the organic constituents is brought about by lowering the pH into the acidic range, and, in the case of a multiple coating,
repeating the first and second step with the product of the preceding coating operation.

It has been found that it is particularly advantageous to bring about the lowering of the pH in the second step of the process by adding hydrogen peroxide to oxidize excess or unreacted formaldehyde from the first step of the process to formic acid. Since formaldehyde is problematic in cosmetic applications, it is thereby possible to provide a pigment which is free from free formaldehyde molecules and is therefore cosmetically acceptable. This also works with methylolunelamines, since they generally still contain sufficient amounts of free formaldehyde.

In the process of the invention, some of the melamine may be replaced by other crosslinking molecules from the group consisting of guanamines, phenols and ureas and/or some of the methylolunelamine may be replaced by corresponding guanamine, phenol or urea analogues.

Before the onset of or during the crosslinking reaction it is possible to add organic or inorganic dyes and/or organic or inorganic UV absorbers.

Should the dyes or UV absorbers not dissolve completely in the aqueous medium, complete dissolution can be brought about by means of solubilizers. This is especially so when using lipophilic substances.

The thickness of the coating can be controlled by the concentration of the melamine-formaldehyde resin. Thus at high concentrations greater thicknesses are obtained than at low concentrations. The pH is another suitable means of controlling the thickness. Low pH levels lead to thinner coatings. Furthermore, DE 1595386 describes the control of layer thicknesses through the addition of protective colloids.

Preferred total layer thicknesses of singly or multiply coated substrates are preferably 0.2 μm to 4 μm.

By using excess melamine-formaldehyde resin it is possible to deposit, on the outermost coating, additional, substantially spherical melamine-formaldehyde resin particles which in addition to organic dyes may also comprise UV absorbers or which are entirely free from dyes or UV absorbers.

Depending on the conduct of the reaction, it is possible to vary the ratio of spheres to platelets, the spherical diameter, and the distribution of the spherical diameter (dispersity). For cosmetic purposes in particular, a certain proportion of the spheres is advantageous for an improved skin sensation.

However, too high a proportion of spheres reduces the brightness and the metallic appearance of the pigment. Given a sufficient portion of dye, the additional spheres have a colouring which matches that of the platelets.

The space/time yield, which is relevant from the standpoint of economics, can be increased significantly by adding polymers containing strongly acidic groups, as is described, for example, in EP 0415273.

The coated platelet-shaped substrates are outstandingly suitable as effect pigments and can be used in all systems commonly including effect pigments.

Accordingly, they can be used on the one hand in (printing) inks, paints, plastics and powder coating materials; on the other hand, the effect pigments are also suitable for seed colouring as seed dressings, in the food sector for enhancing foods or the food design, or in the cosmetic sector, for example, in makeups, lipsticks or sun protection formulations.

For certain applications, for example in paints, inks and the like, it may be advantageous to incorporate functional groups other than the stated strongly acidic groups into the condensation product of the outermost layer of the polymer, in order to improve it in terms, for example, of its binder compatibility and dispersion behaviour. Subsequently providing the outermost layer of the crosslinked organic polymer with functional groups by subsequent reaction of the melamine-formaldehyde resins is a further possibility. DD 224 602 describes various possibilities for the functionalization of resins.

Functional groups in the sense of this invention may be any desired hydrophilic or hydrophobic, acidic or basic groups, thus including, for example, purely hydrophobic, substantially inert groups such as alkyl groups.

In accordance with a method described in DD 224 602, functional groups are incorporated into the surface of the polymer particles by effecting the polycondensation reaction of the melamine-formaldehyde resin in the presence of amino-functional compounds which in addition to the amino group carry further functional groups. The amino-functional compounds are added in amounts of preferably from 2 to 20 mol per cent based on the amount of methylolunelamine used, and are incorporated into the melamine-formaldehyde network by way of the amino function. Thus when using, for example, amino acids it is possible to incorporate carboxyl groups or, in the case of sulphobetaines or aminophosphonic acids, sulpho groups or phosphonic acid groups, respectively, into the surface of the particles. —COOH, —SO₃H and/or —PO₂H groups of this kind may in turn be reacted with other compounds. For example, the acid groups can be converted into the corresponding acid chlorides by reaction with thionyl chloride, and these acid chlorides can in turn be reacted, for example, with alcohols or amines to give the corresponding esters or amides, respectively. This method of surface modification is characterized by its simplicity, since the surface of the melamine-formaldehyde resin is functionalized directly in one, easily modified, condensation operation. However, a possible disadvantageous effect is the incorporation, as a result of the condensation operation, of the corresponding functionalities in the polymer bulk as well, which may reduce adhesion to the underlying layers or, in the case of a single-layer system, adhesion to the substrate. On the other hand, given an appropriate selection, for certain systems the adhesion to the underlying layers or to the substrate may be enhanced if the surface modifier introduces groups which not only improve compatibility with the ambient medium but also impart adhesion to the underlying layers or to the substrate. As a result of incorporation into the melamine-formaldehyde network, however, this method requires relatively large quantities of the surface functionalizer. Additionally, relatively complex chemical functionalities are only obtainable with difficulty by simple incorporation during the polycondensation.

Another method of surface functionalization therefore starts from a ready-polycondensed melamine-formaldehyde surface which has free, uncrosslinked methylolunelamine (NH—CH₂OH—) or amino groups. These groups may be reacted, for example, with carbonyl chlorides in a simple way. When using long-chain carbonyl chlorides, for example, it is possible to hydrophobize the pigment in this way. Using perfluorinated acid chlorides such as perfluorooctanoic acid, for example, both hydrophobic and lipophobic surfaces may be obtained. Through the use of complex acid chlorides, which may contain, for example, groups which are strong absorbers of UV light, the melamine-formaldehyde surface may also contain further functionalities, e.g. a UV protectant. One example of the subsequent hydrophobization of a pigment surface is depicted in Example 9.

The examples below are intended to illustrate the present invention.

### EXAMPLE 1

0.63 g of 2,4,6-triamino-1,3,5-triazine (melamine) is dissolved in 50 ml of water having a temperature of 70° C. Then 0.05 ml of tetramethylammonium hydroxide (25% by weight) and 2.43 g of formaldehyde solution (37% by weight) are added with stirring. The formylation reaction takes place at a pH of 9.5. The clear solution is stirred for 10 minutes and then 1.51 g of mica (average particle size 15 μm) are added. After one minute 0.3 ml of hydrogen peroxide (30% by weight) is added dropwise to the suspension in order to oxidize free formaldehyde to formic acid. The pH falls steadily to about 3.5, the condensation reaction of the melamine resin beginning after about 5 minutes. Stirring is continued for 15 minutes in order to complete the reaction. Throughout, the reaction temperature is maintained at 70° C. Thereafter the coated mica is filtered off, washed with water and dried in a drying cabinet at 105° C for 1 h.

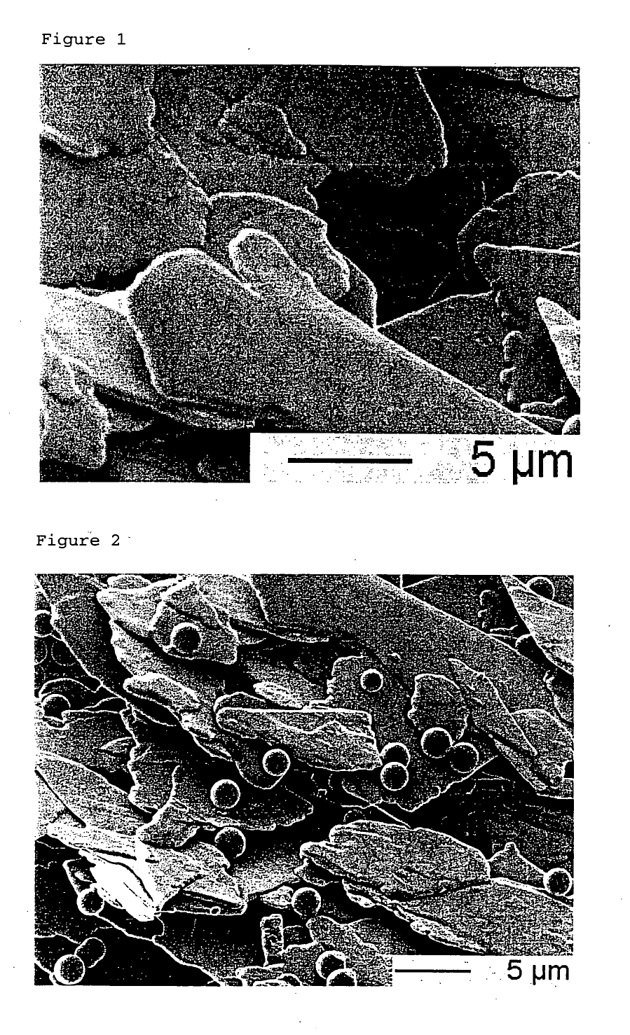

When tested by rubbing between the fingers, the resulting product gives a softer, more pleasant skin sensation than the uncoated mica, which leaves a dull impression on the skin. As shown in FIG. 1, the edges are rounded.

In optical terms, this mica is somewhat brighter than the uncoated mica.

### EXAMPLE 2

Example 2 is conducted in analogy to Example 1 except that additionally, at the same time as the melamine is added, 0.05 g of Allura® Red C.I. 16035 (available from Sigma-Aldrich, Art. No. 48,884-8) is stirred in, and the 1.51 g of mica are replaced by the same amount of silica flakes.

The dried, coated silica flakes thus obtained have an extremely high, metallic brightness which qualifies the product as an attractive effect pigment. The starting materials used are cosmetically acceptable and possess an improved skin sensation as compared with uncoated pigments.

### EXAMPLE 3

1.5 g of Madurit® SMW 818 (Solutia, Wiesbaden, Germany), 2 ml of a saturated solution of Zaponschwarz X50 (lipophilic chromium complex dye, BASF AG, Ludwigshafen, Germany), 2 ml of 1-methyl-2-pyrrolidone and 1.5 g of silica flakes are added in succession at room temperature to 50 ml of water, and the mixture is stirred and heated to 70° C. The coating operation is initiated by adding 3 ml of 2% strength by weight formic acid solution. A grey-black pigment having strongly opalescent properties is obtained.

### EXAMPLE 4

1.5 g of Madurit® SMW 818 (Solutia, Wiesbaden, Germany), 0.03 g of Victoria Blue BO, 2 ml of 1-methyl-2-pyrrolidone and 1.5 g of silica flakes are added in succession at room temperature to 50 ml of water, and the mixture is stirred and heated to 70° C. The coating operation is initiated by adding 1 ml of 2% strength by weight formic acid solution. Following the addition of formic acid, stirring is continued at 70° C. for 30 minutes. A blue pigment having high brightness and opalescent properties is obtained.

### EXAMPLE 5

1.5 g of Madurit® SMW 818 (Solutia, Wiesbaden, Germany), and 0.7 g of mica are added in succession at room temperature to 50 ml of water and the mixture is stirred and heated to 70° C. The coating operation is initiated by adding 1 ml of 2% strength by weight formic acid solution. Following the addition of the formic acid, stirring is continued at 70° C. for 30 minutes. The melamine-formaldehyde resin, which is in excess in relation to the amount of mica, is deposited on the surface of the pigment in the form of substantially spherical monodisperse spheres (see FIG. 2). The spherical fraction, together with the rounding of the edges of the coated substrate as a result of the coating of melamine-formaldehyde resin, gives the product a pleasant skin sensation. This can be ascertained simply from rubbing the product between the fingers.

### EXAMPLE 6

1.5 g of aluminium flakes (Sigma-Aldrich, Art. No. 51,858-1), 1.5 g of Madurit® SMW 818 (Solutia, Wiesbaden, Germany) and 0.02 g of Victoria Blue BO, are added in succession at room temperature to 50 ml of water, and the mixture is stirred and heated to 70° C. The coating operation is initiated by adding 2.5 ml of 2% strength by weight formic acid solution. Following the addition of formic acid, stirring is continued at 70° C. for 30 minutes. A homogeneous blue coating of the aluminium-flakes is obtained.

### EXAMPLE 7

0.75 g of silica flakes is coated with a thin layer of silver in an ammoniacal silver nitrite solution by adding glucose. The silverized and washed flakes are suspended in 25 ml of water, 0.75 g of Madurit® SMW 818 (Solutia, Wiesbaden, Germany) and 0.03 g of methyl orange are added, and the mixture is stirred and heated to 70° C. The coating operation is initiated by adding 1.25 ml of 2% strength by weight formic acid solution. A very attractive gold-metallic pigment is obtained.

### EXAMPLE 8

In a first stage, 1.5 g of ground mica is suspended at room temperature in 50 ml of water, 1.5 g of Madurit® SMW 818 (Solutia, Wiesbaden, Germany) and 0.05 g of Supracene violet 3B are added, and the mixture is stirred and heated to 70° C. The coating operation is initiated by adding 1 ml of 2% strength by weight formic acid solution. Following the addition of the formic acid, stirring is continued at 70° C. for 30 minutes. A blue-violet pigment is obtained which is washed and transferred to a second reaction vessel. The product obtained in the first stage is suspended in 50 ml of water. 1.5 g of Madurit® SMW 818 (Solutia, Wiesbaden, Germany) and 0.1 g of Blankophor PM (fluorescent dye from Bayer) are added. The mixture is subsequently heated to 70° C. with stirring. The second coating operation is initiated by adding 1.5 ml of 2% strength by weight formic acid solution. Addition of the formic acid is followed by stirring at 70° C. for 30 minutes. As compared with the product of the first stage, the final product has a paler blue-violet as its base colour, accompanied by a UV fluorescence at 365 nm, obtained by virtue of the second coating.

### EXAMPLE 9

1 g of a mica coated with Allura Red (C.I: 16035) and melamine-formaldehyde resin (pigment from Example 2) is dried in a vacuum drying cabinet at 105° C. and 200 mbar for 24 hours. The pigment is subsequently suspended in 50 ml of dried toluene. While stirring with a magnetic stirrer, 0.5 ml of dried pyridine and 0.5 ml of stearoyl chloride are added to this suspension. The mixture is stirred at 60° C. for 3 hours. It is then poured into 200 ml of water and the organic phase is separated off. The aqueous phase is washed twice with 50 ml of toluene in order to remove unreacted acid chloride and hydrolysed acid chloride. The sediment of the aqueous phase is separated off, then washed with a mixture of water and ethanol and dried in a vacuum drying cabinet at 105° C.

The dried, hydrophobically functionalized colour pigment is used to carry out wetting tests in water and toluene. As compared with the hydrophilic colour pigment which has not been functionalized, a markedly hydrophobic behaviour is in contrast found with water. In the case of wetting with toluene, on the other hand, the stearic-acid-functionalized colour pigment possesses a much better wettability.

### EXAMPLE 10

1 ml of 2% strength formic acid is added at 70° C. with vigorous stirring to a mixture composed of 1.5 g of. F-mica (mica with a thickness of about 1 μm and a diameter of about 10-30 μm (Merck KGaA), 1.5 g of Madurit SWM 818 (Solutia AG), 50 ml of water, 0.1 ml of Blankophor P liquid (optical brightener; Bayer AG) and 0.5 mg of Rhodamin B (fluorescent dye; Merck KGaA). The operation of coating the mica with the two dyes is over after about 15 minutes. The solid is filtered off with suction, washed and dried. The product obtained exhibits a vigorous red fluorescence on excitation with light having a wavelength of 366 nm.

Comparative Examples 1 and 2 below show that the individual dyes do not possess this property.

### COMPARATIVE EXAMPLE 1

1 ml of 2% strength formic acid is added at 70° C. with vigorous stirring to a mixture composed of 1.5 g of F-mica (mica with a thickness of about 1 μm and a diameter of about 10-30 μm (Merck KGaA), 1.5 g of Madurit SWM 818 (Solutia AG), 50 ml of water and 0.1 ml of Blankophor P liquid (optical brightener; Bayer AG). The operation of coating the mica with Blankphor P is over after about 15 minutes. The solid is filtered off with suction, washed with deionized water and dried. The product obtained exhibits an intense blue-white fluorescence on excitation with light having a wavelength of 366 nm.

### COMPARATIVE EXAMPLE 2

1 ml of 2% strength formic acid is added at 70° C. with vigorous stirring to a mixture composed of 1.5 g of F-mica, 1.5 g of Madurit SWM 818 (Solutia AG), 50 ml of water and 0.5 mg of Rhodamin B (fluorescent dye, Merck KGaA). The operation of coating the mica with Rhodamin B is over after about 15 minutes. The solid is filtered off with suction, washed and dried. The product obtained exhibits a very weak red fluorescence on excitation with light having a wavelength of 366 nm.

### EXAMPLE 11

1 ml of 2% strength formic acid is added at 70° C. with vigorous stirring to a mixture composed of 1.5 g of F-mica (Merck), 1.5 g of Madurit SWM 818 (Solutia AG), 50 ml of water, 0.1 ml of Blankophor P liquid (optical brightener; Bayer AG) and 0.5 mg of acridine (fluorescent dye; Aldrich). The operation of coating the mica with the two dyes is over after about 15 minutes. The solid is filtered off with suction, washed with deionized water and dried. The product obtained exhibits a neutral-white fluorescence on excitation with light having a wavelength of 366 nm.

The result without acridine has already been described in Comparative Example 1 (blue-white fluorescence).

The same mixture as in Example 11 without Blankophor P liquid leads to a product without fluorescence properties on excitation with light having a wavelength of 366 nm.

1. Coated platelet-shaped carrier material, characterized in that the carrier material is composed of an inorganic substrate and is provided with at least one coating, each layer comprising at least one cured melamine-formaldehyde resin or being composed of such a resin.

2. Coated platelet-shaped carrier material according to claim 1, characterized in that the inorganic carrier material is selected from the group consisting of mica, silica flakes, glass flakes, pearlescent pigments, metal flakes and metal foils.

3. Coated platelet-shaped carrier material according to claim 1, characterized in that the metal flakes or metal foils are composed of silver, copper, nickel, gold, aluminium or alloys of these metals.

4. Coated platelet-shaped carrier material according to claim 1, characterized in that the inorganic substrate has a metallic coating.

5. Coated platelet-shaped carrier material according to claim 4, characterized in that the metallic coating is composed of silver, copper, nickel, gold, aluminium or alloys of these metals.

6. Coated platelet-shaped carrier material according to claim 1, characterized in that the cured melamine-formaldehyde resin comprises one or more organic or inorganic dyes and/or one or more organic or inorganic UV absorbers, the dyes being soluble in the medium in which the pigment is coated.

7. Coated platelet-shaped carrier material according to claim 6, characterized in that the dye or dyes is or are present in one or more inner layers comprising melamine-formaldehyde resin and the UV absorber or absorbers is or are present in one or more outer layers comprising melamine-formaldehyde resin.

8. Coated platelet-shaped carrier material according to claim 1, characterized in that substantially spherical cured melamine-formaldehyde resin particles which comprise one or more dyes and/or one or more W absorbers or else are free from dyes and/or UV absorbers are additionally applied to the outermost coating.

9. Coated platelet-shaped carrier material according to claim 1, characterized in that the cured melamine-formaldehyde resin of the outermost layer is modified with functional groups.

10. Coated platelet-shaped carrier material according to claim 9, characterized in that the functional groups which modify the outermost layer are introduced by way of amino-functional compound which in addition to the amino group contains one or more further functional group, this amino-functional compound participating in the polycondensation reaction between melamine and formaldehyde and being incorporated into the melamineformaldehyde network by way of the amino function, with the functional groups brought to the surface in this way being modified further where appropriate.

11. Coated platelet-shaped carrier material according to claim 9, characterized in that the cured melamineformaldehyde resin of the outermost layer is surface-functionalizing modified with compounds reactive towards hydroxyl and/or amino groups by way of the methylolamine or amino groups present in the said resin.

12. Coated platelet-shaped carrier material according to claim 6, the melamine-formaldehyde resin comprising as dyes at least one fluorescent dye and one further, optionally fluorescent dye, the further dye being present in an amount which gives the pigment essentially no colour or fluorescence when this dye is used alone.

13. Process for producing a singularly or multiply coated platelet-shaped carrier material, characterized in that it comprises, in the case of a single coating, a first step in which an inorganic platelet-shaped substrate is suspended in a basic aqueous medium, comprising melamine and formaldehyde and/or methylolunelamine, which may optionally have been alkoxylated, and a second step in which crosslinking of the organic constituents is brought about by lowering the pH into the acidic range, and, in the case of a multiple coating, repeating the first and second steps with the product of the preceding coating operation.

14. Process according to claim 13, characterized in that some of the melamine is replaced by other crosslinking molecules from the group consisting of guanamines, phenols and ureas and/or some of the methylolunelamine is replaced by corresponding guanamine, phenol or urea analogues.

15. Process according to claim 13, characterized in that, before the onset of or during crosslinking, organic or inorganic dyes and/or organic or inorganic UV absorbers are added.

16. Process according to claim 15, characterized in that dyes added comprise at least one fluorescent dye and one further, optionally fluorescent dye, the further dye being added in an amount which gives the pigment essentially no colour or fluorescence when this dye is used alone.

17. Process according to claim 13, characterized in that the lowering of the pH into the acidic range is brought about by oxidation of excess and/or unreacted formaldehyde and/or formaldehyde present in the methylolunelamines, by means of hydrogen peroxide.

18. Process according to claim 13, characterized in that in the final coating step, in addition to melamine and formaldehyde and/or methylolunelamine, an amino-functional compound which in addition to the amino group contains one or more functional groups participates in the polycondensation reaction, the amino-functional compound being incorporated into the melamine-formaldehyde network by way of the amino function, and with the functional groups brought to the surface in this way being modified further where appropriate.

19. Process according to claim 13, characterized in that the cured melamineformaldehyde resin of the outermost layer is reacted by way of the methylolamine or amino groups present on its surface with compounds which contain a group which is reactive towards hydroxyl and/or amino groups, in addition to one or more further functional groups.

20. Use of one or more of the coated platelet-shaped carrier materials of claim 1 as effect pigments in paints, varnishes, printing inks, plastics, powder coating materials, for colouring seed, in cosmetic formulations and/or for pigmenting foods.

21. Use according to claim 20 for the purpose of marking and/or coding products.

22. Compositions comprising one or more of the coated platelet-shaped carrier materials of claim 1 as effect pigment.
